(19) United States
(12) Patent Application Publication
(10) Pub. No.: US 2008/0041690 A1
(43) Pub. Date: Feb. 21, 2008

(54) Bill processing device and bill processing method

(75) Inventor: Osamu Ito, Kawaguchi-Shi (JP)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(73) Assignee: Glory Ltd., Himeji-Shi (JP)

(21) Appl. No.: 11/891,986

(22) Filed: Aug. 14, 2007

(30) Foreign Application Priority Data
Aug. 15, 2006 (JP) 2006-221486

(51) Int. Cl. G07F 7/04

(52) U.S. Cl. 194/206; 414/800

(57) ABSTRACT

A bill processing device 10 comprising a hopping part 101 for receiving a placed bill, a carrying part 202 for transferring the bill received by the hopping part 101, a identifying part 201 for identifying a bill carried by the carrying part 202, a memory 31 for storing an identification result of the identifying part 201, a recording media slotting part 111 for receiving recording media 32 in which registered information 321 is stored, a registered information reading part 112 for reading the registered information 321 stored in the recording media 32 received by the recording media slotting part 111, and a controlling part 30 for controlling the hopping part 101, the carrying part 202, the identifying part 201, the memory 31, the recording media slotting part 111 and the registered information reading part 112. When the recording media 32 is received by the recording media slotting part 111, the controlling part 30 controls them to read the registered information 321 stored in the recording media 32, to associate the registered information 321 and the identification result of the identifying part 102 with each other and to store the same in the memory 31.

### BACKGROUND OF THE INVENTION

1. Field of the Invention

The present invention relates to a bill processing device and a bill processing method, and more particularly, to a bill processing device and a bill processing method for reducing manually input operation when a plurality of transactions are batched.

2. Related Art

In recent years, as a processing ability of a bill processing device is enhanced, a bill processing device capable of batching a plurality of transactions is required.

Conventionally, when a plurality of transactions are batched, it is necessary that an operator manually inputs information which recognizes each transaction. However, time required for the manually input operation is longer than time required for processing bills. Therefore, even if the processing ability of the bill processing device is enhanced, the time required for the manually input operation becomes a bottleneck and as a result, the productivity of the bill processing device is not largely enhanced.

Japanese Patent Applications Laid-open Publication No. 2006-99391 and No. 2000-50356 disclose technology for solving such a problem. These technologies are for recognizing transactions when receiving bills by inserting a separator card on which information inherent in each transaction.

According to the technologies described in Japanese Patent Applications Laid-open Publication No. 2006-99391 and No. 2000-50356, however, if a reject bill (e.g., bill which can not be counted due to damage or the like) exists, since such a reject bill is not included in a transaction, a received result and actual transaction contents do not match with each other. In this case, it is necessary that an operator carries out the manually input operation, and corrects the receiving result while taking the reject bill into account.

According to the technologies described in Japanese Patent Applications Laid-open Publication No. 2006-99391 and No. 2000-50356, an operator is required to carry out the manually input operation if a reject bill exits.

A general bill processing device has only one hopping opening for reject bills. Therefore, reject bills which are returned in a plurality of transactions are mixed. In this case, it is difficult to know that which reject bill corresponds to which transaction, and time required for checking operation becomes extremely long.

### BRIEF SUMMARY OF THE INVENTION

According to the first aspect of the present invention, there is provided that a bill processing device comprising a hopping part for receiving a placed bill, a carrying part for transferring the bill received by the hopping part, a identifying part for identifying a bill carried by the carrying part, a memory for storing an identification result of the identifying part, a recording media slotting part for receiving recording media in which registered information is stored, a registered information reading part for reading the registered information stored in the recording media received by the recording media slotting part, and a controlling part for controlling the hopping part, the carrying part, the identifying part, the memory, the recording media slotting part and the registered information reading part, wherein when the recording media is received by the recording media slotting part, the controlling part controls them to read the registered information stored in the recording media, to associate the registered information and the identification result of the identifying part with each other and to store the same in the memory.

According to the second aspect of the present invention, there is provided that a bill processing method comprising, a step for receiving a recording media on which registered information is recorded, a step for reading the registered information stored in the received recording media, a step for receiving a placed bill, a step for identifying the received bill, a step for storing the read registered information and an identification result of the identifying step while associating the registered information and the identification result with each other.

### BRIEF DESCRIPTION OF THE SEVERAL VIEWS OF THE DRAWING

FIG. 1 illustrates a perspective view showing external structures of a bill processing device 10 and a recording media reading device 11;

FIG. 2 illustrates a schematic diagram showing an internal structure of the bill processing device 10;

FIG. 3 illustrates a block diagram showing functions of the bill processing device 10 and the recording media reading device 11;

FIGS. 4A to 4C illustrate one example of temporary memory information 312 and memory information 311 stored in a memory 31, and registered information 321 stored in recording media 32;

FIG. 5 illustrates a flowchart showing processing of a controlling part 30 according to an embodiment of the present invention when a transaction is processed; and

FIG. 6 illustrates a flowchart showing processing of the controlling part 30 when it is determined No in S511 of FIG. 5.

### DETAILED DESCRIPTION OF THE INVENTION

An embodiment of the present invention will be explained with reference to the drawings. The embodiment is only one example and the present invention is not limited to the embodiment.

### Embodiment 1

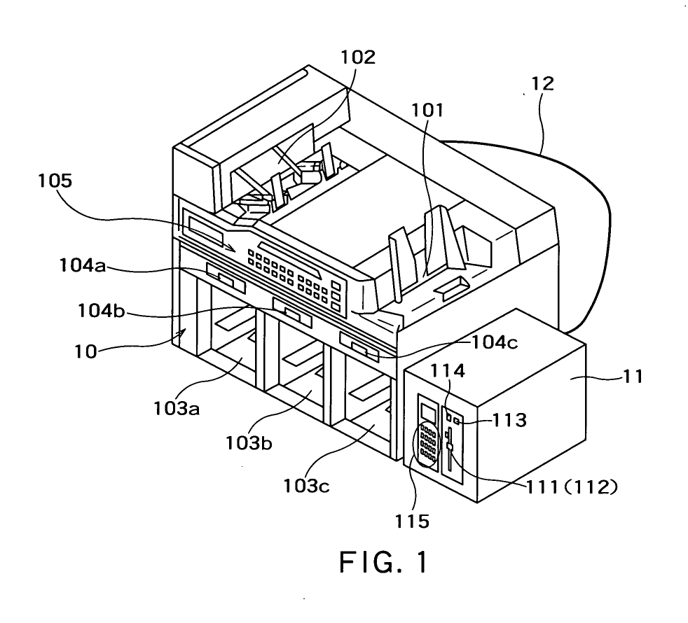

FIG. 1 illustrates a perspective view showing external structures of a bill processing device 10 and a recording media reading device 11.

The bill processing device 10 includes a hopping part 101, a rejecting part 102, a stacking part 103, an alarming part 104 and an operating and displaying part 105.

The hopping part 101 has a mechanism for receiving bills put by an operator into the bill processing device 10. The rejecting part 102 returns a reject bill (e.g., bill which can not be recognized and counterfeit bill) existing in bills received by the hopping part 101. The stacking part 103 has a mechanism for stacking bills received by the hopping part 101. In this embodiment, the stacking part 103 has three stacking parts 103a to 103c for respectively stacking different kinds of bills. The alarming part 104 is provided in correspondence with the stacking part 103, and has a mechanism for output characters, sound or light when it is necessary to inform an operator. In this embodiment, the alarming part 104 comprises alarming parts 104a to 104c corresponding to the stacking parts 103a to 103c. The operating and displaying part 105 has a key input part for receiving instructions from an operator and a display part for showing information to the operator. The number of the stacking part 103 and the alarming part 104 is not limited.

The recording media reading device 11 includes a recording media slotting part 111, a recording media reading part 112 (not shown), an end key 113, a cancel key 114 and ten keys 115. The recording media reading device 11 is connected to the bill processing device 10 through a connection line 12.

The recording media slotting part 111 has a mechanism for receiving recording media inserted by operators.

The recording media reading part 112 has a mechanism for reading registered information registered in the recording media received by the recording media slotting part 111.

The end key 113, the cancel key 114 and the ten keys 115 are for receiving instructions from operators. The ten keys 115 are for receiving instructions from operators and are not limited to numeric keys.

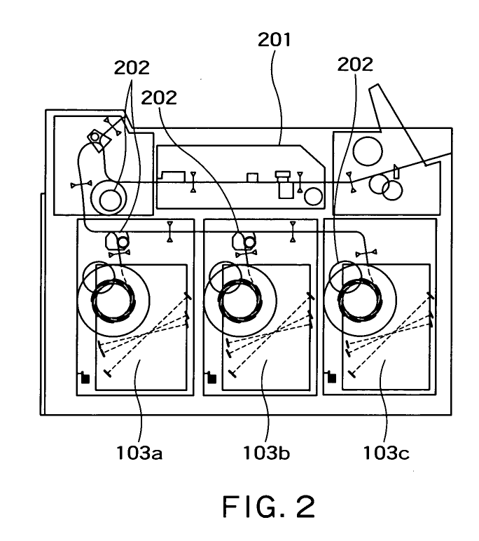

FIG. 2 illustrates a schematic diagram showing an internal structure of the bill processing device 10.

The bill processing device 10 includes a identifying part 201 and carrying parts 202.

The identifying part 201 has a mechanism for identifying “denominations” and “real bill or counterfeit bill” of bill received from the hopping part 101. Each carrying part 202 has a mechanism for carrying a bill to the rejecting part 102 or the stacking part 103 from the hopping part 101.

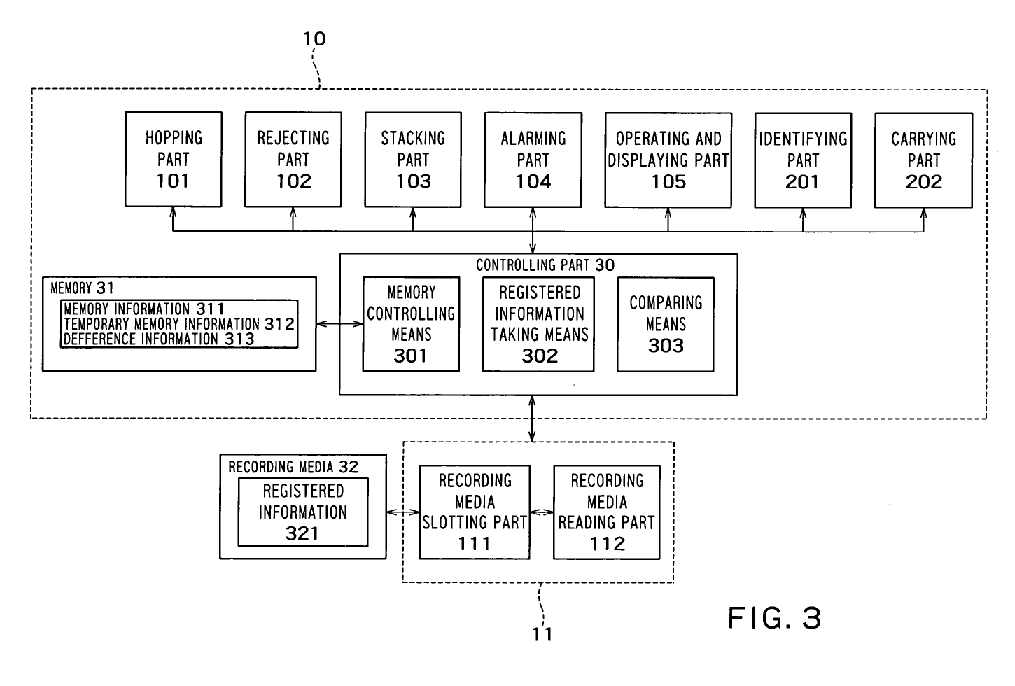

FIG. 3 illustrates a block diagram showing functions of the bill processing device 10 and the recording media reading device 11.

The controlling part 30 gives operation instructions to the hopping part 101, the rejecting part 102, the stacking part 103, the alarming part 104, the operating and displaying part 105, the identifying part 201 and the carrying part 202. The hopping part 101, the rejecting part 102, the stacking part 103, the alarming part 104, the operating and displaying part 105, the identifying part 201 and the carrying part 202 are operated in accordance with the operation instructions from the controlling part 30. The controlling part 30 includes memory controlling means 301, registered information taking means 302 and comparing means 303.

The memory controlling means 301 reads and writes data between itself and the memory 31 of the bill processing device 10.

The registered information taking means 302 obtains registered information which is read by the recording media reading part 112 of the recording media reading device 11.

The comparing means 303 compares the registered information 321 obtained by the registered information taking means 302 and the temporary memory information 312 stored in the memory 31 with each other.

The memory 31 can store various information including the memory information 311, the temporary memory information 312 and difference information 313.

The recording media 32 can store various information including the registered information 321.

For example, the controlling part 30 is a central processing unit (CPU). For example, the memory 31 is a hard disk. For example, the recording media 32 are flash memories or paper media on which the coded information is printed. For example, the coded information is a bar code, a character or a symbol printed in an arbitrary form. For example, the recording media reading part 112 is a bar code reader or an optical character reader (OCR).

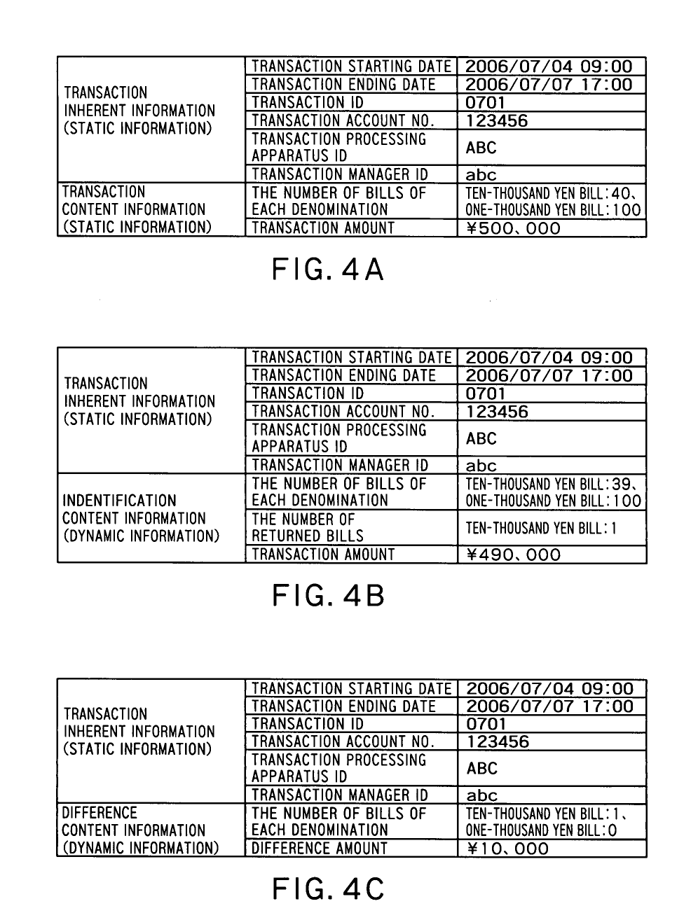

FIG. 4A to 4C illustrate one example of information stored in the memory 31 and recording media 32.

FIG. 4A illustrates one example of the registered information 321 stored in the recording media 32.

The registered information 321 comprises transaction inherent information (static information) and transaction content information (static information).

The transaction inherent information is information for specifying a transaction, and includes transaction starting date and time, transaction ending date and time, transaction ID, transaction account number, transaction processing apparatus ID and transaction manager ID. The transaction content information is information showing contents of a transaction, and includes the number of bills of each denomination and transaction amount. The transaction inherent information and the transaction content information included in the registered information 321 can not be rewritten (static information) until a transaction is completed, and such information may be rewritten (dynamic information) when the transaction is completed.

FIG. 4B illustrates one example of memory information 311 and temporary memory information 312 stored in the memory 31.

Each of the memory information 311 and temporary memory information 312 comprises transaction inherent information (static information) and identification content information (dynamic information). The transaction inherent information has the same configuration as that of the registered information 321. The identification content information includes the number of bills of each denomination, the number of returned bills and a transaction amount which are identification result by the identifying part 201. The identification content information can be rewritten.

FIG. 4C illustrates one example of the difference information 313. The difference information 313 comprises transaction inherent information (static information) and difference content information (dynamic information). The transaction inherent information has the same configuration as that of the registered information 321. The difference content information shows a result of comparison made by the comparing means 303, and includes the number of difference of each denomination, and a difference amount. The difference content information can be rewritten.

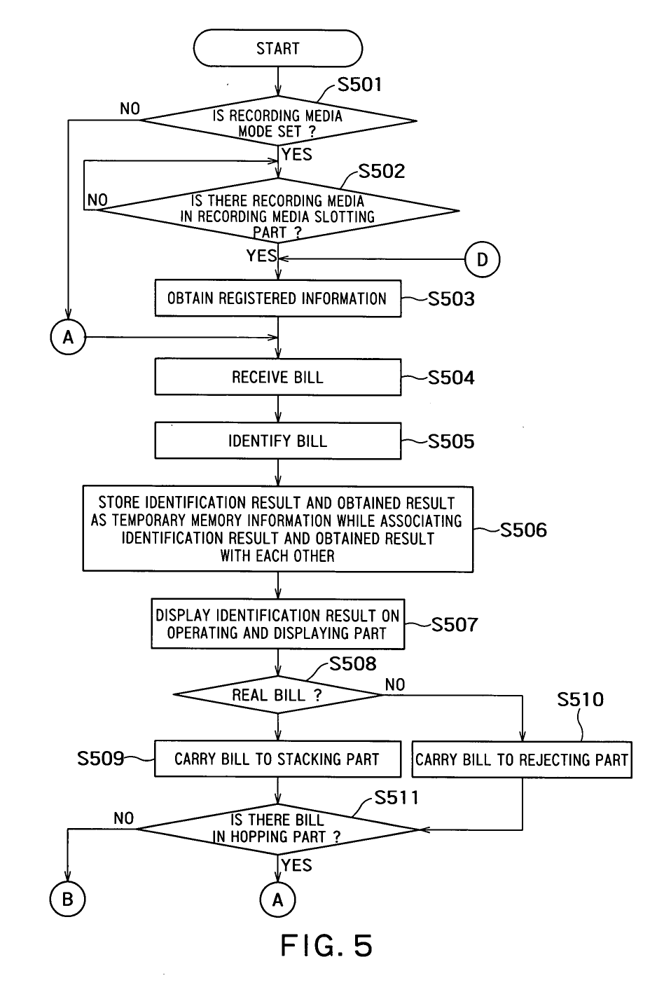

FIG. 5 illustrates a flowchart showing processing of the controlling part 30 according to the present invention when a transaction is processed.

First, when a plurality of bills which comprise a plurality of denominations are placed on the hopping part 101 and a predetermined key of the operating and displaying part 105 (requests to start the processing of transaction) pushed by an operator, it is determined whether a recording media mode is set (S501).

When the recording media mode is set (S501—Yes), the controlling part 30 controls them to wait until the recording media 32 is received by the recording media slotting part 111 (S502).

When the recording media slotting part 111 receives the recording media 32 (S502—Yes), the recording media reading part 112 reads the registered information 321, and the read registered information 321 is obtained (S503).

Then, the hopping part 101 receives the placed bills (S504).

Then, the identifying part 201 identifies the received bills (S505).

In step S505, the identifying part 201 checks the “denominations” and whether “real bill or counterfeit bill”. Next, the transaction inherent information included in the registered information 321 obtained in step S503 and the identification content information recognized in step S505 are associated with each other, and they are stored as the temporary memory information 312 in the memory 31 (S506).

Next, the identification content information recognized in step S505 is displayed on the operating and displaying part 105 (S507).

Then, when a fact that the bill is a real bill is included in the identification content information recognized in step S505, the bill is transferred to the stacking part 103 (S508—Yes, S509), and when a fact that the bill is not a real bill is included in the identification content information, the bill is transferred to the rejecting part 102 (S508—No, S510).

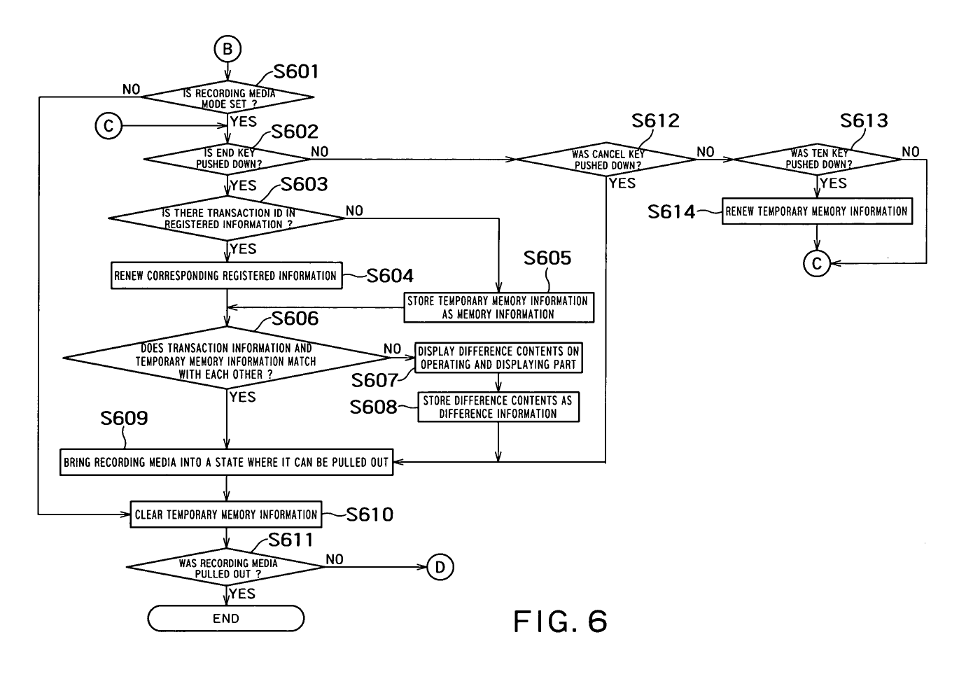

Then, when a bill remains in the hopping part 101, the procedure is shifted to S504 (S511—Yes), and when no bill remains, the procedure is shifted to FIG. 6 (S511—No).

By making the determination in step S511, the receiving processing in the hopping part 101 preferentially is carried out, and the processing efficiency of the entire bill processing device 10 can be enhanced.

On the other hand, when the recording media mode is not set (S501—No), the procedure is shifted to S504.

FIG. 6 illustrates a flowchart showing processing of the controlling part 30 when it is determined No in S511.

When the recording media mode is set (S601—Yes), it is determined whether the end key 113 is pushed down (S602). If the end key 113 is pushed down (S602—Yes), it is determined whether the transaction inherent information included in the temporary memory information 312 stored in S506 exists in the memory 31 (S603). This determination is made by retrieving the information in the memory 31 using the transaction ID as a keyword. When the transaction inherent information exists in the memory 31 (S603—Yes), the identification content information of the memory information 311 is renewed (S604).

When the transaction inherent information does not exists in the memory 31 (S603—No), the temporary memory information 312 is stored in the memory 31 as the memory information 311 (S605).

Next, it is determined whether the transaction content information of the registered information 321 and the identification content information of the temporary memory information 312 match with each other (S606). When they match with each other (S606—Yes), the recording media 32 is brought into a state where the recording media 32 can be pulled out (S609).

When they do not match with each other (S606—No), the difference content information is displayed on the operating and displaying part 105 (S607), the difference content information and the transaction inherent information are associated with each other, they are stored in the memory 31 as the difference information 313 (S608), and the procedure is shifted to S609.

Then, the temporary memory information 312 stored in the memory 31 is cleared (S610).

Next, it is determined whether the recording media 32 is pulled out from the recording media slotting part 111 (S611). If the recording media 32 is pulled out, the transaction is completed (S611—Yes).

If the recording media 32 is received by the recording media slotting part 111 again (S611—No), the procedure is shifted to S503.

When No in S602, it is determined whether the cancel key 114 is pushed down (S612). When the cancel key 114 is pushed down, the procedure is shifted to S609 (S612—Yes).

When No in S612, the controlling part 30 controls them to wait until the ten key 115 is pushed down (S613). If one of ten keys 115 is pushed down (S613—Yes), the identification content information included in the temporary memory information 312 is renewed according to the pushed key and the procedure is shifted to S602.

When the recording media mode is not set (S602—No), the procedure is shifted to S610.

According to the above embodiment of the present invention, when the recording media mode is set, the transaction inherent information stored in the recording media 32 and the identification content information identified by the identifying part 201 are associated with each other and they are stored as the temporary memory information 312 or the memory information 311 (S506). Therefore, the manually input operation of an operator can be reduced.

When the recording media mode is set, a fact that the recording media 32 is inserted into the recording media slotting part 111 becomes an operation condition (S502). Therefore, a relation between bills processed by the bill processing device 10 and transactions becomes a one-to-one relation. Thus, it is possible to store the transaction inherent information and the identification content information including presence and absence of a reject bill, and even if a reject bill exists, it is possible to reduce the manually input operation of an operator.

### Embodiment 2

Although the bill processing device 10 and the recording media reading device 11 are connected to each other through the connection line 12 in the embodiment 1, but the present invention is not limited to this. The recording media reading device 11 may be incorporated in the bill processing device 10, i.e., the bill processing device 10 is provided therein with the recording media slotting part 111, the recording media reading part 112, the end key 113, the cancel key 114 and the ten keys 115. Radio or wireless means may be used instead of the connection line 12.

According to the embodiment 2 of the present invention, since the bill processing device 10 and the recording media reading device 11 are formed as one unit, the entire bill processing system can be reduced in size, and the system can be applied more widely.

What is claimed is:

1. A bill processing device comprising:
a hopping part for receiving a placed bill,
a carrying part for transferring the bill received by the hopping part,
a identifying part for identifying a bill carried by the carrying part,
a memory for storing an identification result of the identifying part,
a recording media slotting part for receiving recording media in which registered information is stored,
a registered information reading part for reading the registered information stored in the recording media received by the recording media slotting part, and
a controlling part for controlling the hopping part, the carrying part, the identifying part, the memory, the recording media slotting part and the registered information reading part, wherein
when the recording media is received by the recording media slotting part, the controlling part controls them to read the registered information stored in the recording media, to associate the registered information and the identification result of the identifying part with each other and to store the same in the memory.

2. The bill processing device according to claim 1, further comprising:
a plurality of stacking parts for stacking bills, wherein
when the recording media is received by the recording media slotting part, the controlling part controls them to stack a bill identified by the identifying part in one of the plurality of stacking parts in accordance with the identification result of the identifying part.

3. The bill processing device according to claim 1, wherein the registered information is static information inherent to each transaction and dynamic information indicating contents of the transaction.

4. The bill processing device according to claim 1, wherein
the registered information is a coded information, the recording media is paper media on which the coded information is printed.

5. The bill processing device according to claim 4, wherein
the registered information reading part recognizes registered information by reading the coded information.

6. The bill processing device according to claim 1, further comprising a display part for displaying predetermined information, wherein
the controlling part controls them to display the identification result of the identifying part and the registered information on the display part.

7. The bill processing device according to claim 6, wherein
the controlling part controls them to compare the identification result of the identifying part and the registered information, and to display a comparison result on the display part.

8. The bill processing device according to claim 7, wherein
when the identification result of the identifying part and the registered information does not match with each other, the controlling part controls to display the comparison result on the display part.

9. The bill processing device according to claim 1, further comprising an alarming part for outputting a character, a sound or light, wherein the controlling part controls them to compare the identification result of the identifying part and the registered information with each other and when they do not match with each other, the controlling part controls the alarming part to output them.

10. The bill processing device according to claim 1, wherein the controlling part compared the identification result of the identifying part and the registered information with each other, and when they do not match with each other, the controlling part controls them to store the comparing result in the memory.

11. The bill processing device according to claim 1, further comprising a key input part for receiving key input from an operator, and wherein
when there is a key input, the controlling part controls them to determinate, to delete or to change the registered information stored in the memory according to the key input.

12. The bill processing device according to claim 11, wherein
when there is a key input, the controlling part controls them to determinate the registered information stored in the memory so that a recording media can be taken out from the recording media slotting part.

13. The bill processing device according to claim 11, wherein
when there is a cancel key input, the controlling part controls them to delete the registered information stored in the memory so that a recording media can be taken out from the recording media slotting part.

14. The bill processing device according to claim 1, wherein
the controlling part controls them only when the recording media is received by the recording media slotting part.

15. The bill processing device according to claim 1, wherein
when the recording media is received by the recording media slotting part, and when information corresponding to the registered information stored in the recording media is stored in the memory, the controlling part controls them to renew the information according to an identification result of the identifying part.

16. A bill processing method comprising:
a step for receiving a recording media on which registered information is recorded,
a step for reading the registered information stored in the received recording media,
a step for receiving a placed bill,
a step for identifying the received bill,
a step for storing the read registered information and an identification result of the identifying step while associating the registered information and the identification result with each other.
